(19) United States
(12) Patent Application Publication
(10) Pub. No.: US 2026/0158965 A1
(43) Pub. Date: Jun. 11, 2026

(54) MARINE BATTERY SYSTEM WITH SOLAR POWER GENERATION

(71) Applicant: Nfuture Inc., Gumi-si Gyeongsangbuk-do (KR)

(72) Inventor: Hyun Young NOH, Gumi-si Gyeongsangbuk-do (KR)

(73) Assignee: Nfuture Inc., Gumi-si Gyeongsangbuk-do (KR)

(21) Appl. No.: 18/976,728

(22) Filed: Dec. 11, 2024

(51) Int. Cl. B60L 58/18; B63H 20/00; B63H 21/17; H02J 7/34

(52) U.S. Cl. CPC B60L 58/18; B63H 20/007; B63H 21/17; B60L 2200/32; H02J 7/342

(57) ABSTRACT

A marine electrical system may include a first electrical subsystem and a second electrical subsystem. A jumper switching device may be interposed between the first and second subsystem. The jumper switching device may have normally open contacts. The first electrical subsystem may remain electrically independent from the second electrical subsystem except when the normally open contacts of the jumper switching device are closed.

### BACKGROUND OF THE INVENTION

The present invention generally relates to marine electrical systems and more particularly to systems for interconnecting multiple batteries on a vessel.

Many recreational boaters use motor driven boats for fishing. Such boats may employ outboard engines as a principal propulsion device.

Additionally recreational fishing boats may also employ battery operated trolling motors to move a boat slowly during fishing activity.

It is common practice to provide a dedicated battery for starting a main engine and a different, electrically independent, battery to supply current to the trolling motor. In some cases, a main engine starting battery may have insufficient charge to start a main engine. Because a trolling motor battery is maintained on a separated circuit from a starting battery, the trolling motor battery may not be readily useable to provide an electrical boost to a starting battery if a boost is needed.

As can be seen, there is a need for a marine electrical system in which a starting battery may be readily provided with a boost from a trolling motor battery if needed.

### SUMMARY OF THE INVENTION

In one aspect of the present invention, a marine electrical system may comprise: a first electrical subsystem; a second electrical subsystem; and a jumper switching device interposed between the first and second subsystem, the device having normally open contacts; the first electrical subsystem being electrically independent from the second electrical subsystem except when the normally open contacts of the jumper switching device are closed.

In another aspect of the present invention, a jumper switching device may comprise: two spring-biased solenoid relays having normally open contacts; first and second positive battery-terminal cables interconnected with first and second contacts of a first one of the solenoid relays; first and second negative battery-terminal cables interconnected with first and second contacts of a second one of the solenoid relays; a switch interconnected between the first positive battery-terminal cable and coil of the solenoid relays at coil terminals; and an electrical connection path from said coil terminals, through said coils to the first negative battery-terminal cable.

These and other features, aspects and advantages of the present invention will become better understood with reference to the following drawings, description and claims.

### BRIEF DESCRIPTION OF THE DRAWINGS

FIG. 1 is a schematic diagram of a marine electrical system in accordance with an embodiment of the invention; and

FIG. 2 is a plan view of a jumper switching device in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide marine electrical systems in which two batteries are maintained in electrically separate states for normal operational purposes but are readily interconnected temporarily when desired.

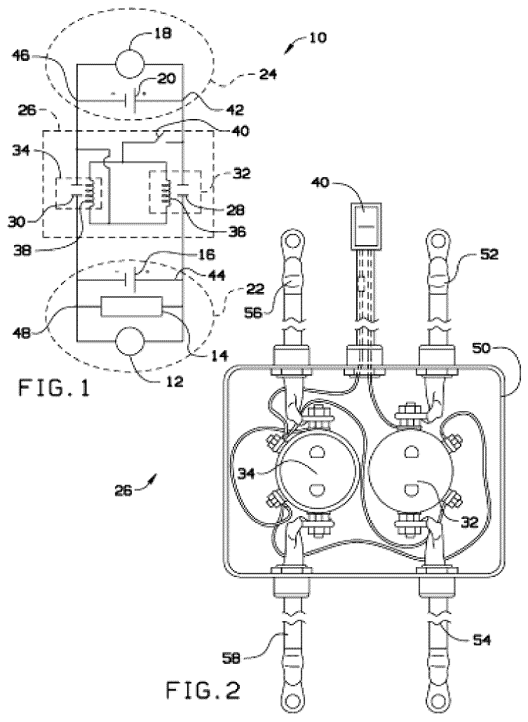

Referring now to FIG. 1, an exemplary embodiment of a marine electrical system 10 may include an engine starting motor 12, a marine electronics system 14, a starting battery 16, a trolling motor 18 and a trolling battery 20. The starting motor 12, marine electronics system 14 and the starting battery 16 may be configured in a first electrical subsystem 22. The trolling motor 18 and the trolling battery 20 may be configured in a second electrical subsystem 24.

A jumper switching device 26 may be interposed between the subsystems 22 and 24. The device 26 may have normally-open sets of contacts 28 and 30. It may be seen that unless the sets of contacts 28 and 30 are closed, the subsystems 22 and 24 may be independently grounded and thus may be electrically independent from one another. Consequently, the marine electronics system 14 may not be adversely affected from electrical transients or other anomalies that may develop through operation of the trolling motor 18.

The jumper switching device 26 may comprise two spring biased solenoid relays 32 and 34 configured to close the contacts 28 and 30 respectively when actuated. Coils 36 and 38 of the relays 32 and 34 may be interconnected with a pushbutton switch 40 so that upon actuation of the switch 40, current from the trolling battery 20 may pass through the coils 36 and 38 thus closing the contacts 28 and 30. Positive terminals 42 and 44 of the batteries 20 and 16 respectively may become interconnected when the contacts 28 close. Negative terminals 46 and 48 of the batteries 20 and 16 respectively may become interconnected when the contacts 30 close.

Thus an operator of a vessel may operate the pushbutton switch 40 to provide a boost from the trolling battery 18 to the starting battery 16 if needed. When the pushbutton switch 40 is released the two electrical subsystems 22 and 24 may revert to their normal electrically independent status.

Referring now to FIG. 2, it may be seen that the jumper switching device 26 may be incorporated in a convenient location in a vessel. For example, the device 26 may be installed on a control panel (not shown), with the pushbutton switch 40 being in a readily accessible location. The device 26 may be incorporated into a waterproof box 50. Cables 52 and 54 may be interconnected with the positive terminals 42 and 44 of the batteries 20 and 16 respectively. Cables 56 and 58 may be interconnected with the negative terminals 46 and 48 of the batteries 20 and 16 respectively. Advantageously the cable 52, 54, 56 and 58 may be marine grade no smaller than No. 4 American Wire Gauge (AWG) cable.

It should be understood, of course, that the foregoing relates to exemplary embodiments of the invention and that modifications may be made without departing from the spirit and scope of the invention as set forth in the following claims.

What is claimed is:

1. A marine electrical system comprising:
a first electrical subsystem;
a second electrical subsystem; and
a jumper switching device interposed between the first and second electrical subsystem, the jumper switching device having normally open contacts,
wherein the first electrical subsystem is electrically independent from the second electrical subsystem except when the normally open contacts of the jumper switching device are closed.

2. The system of claim 1, wherein the jumper switching device comprises spring-biased solenoid relays with normally open contacts.

3. The system of claim 2, wherein:
the first subsystem includes a first battery;
the second subsystem includes a second battery;
a first one of the solenoid relays is interposed between positive terminal of the first and second batteries; and
a second one of the solenoids is interposed between negative battery terminals of the first and second batteries.

4. The system of claim 2, wherein:
the first electrical subsystem included a main-engine starting motor and a starting battery;
the second electrical subsystem includes a trolling motor and a trolling battery; and
the solenoid relays are connected to operate with power from the trolling battery.

5. The system of claim 4, further comprising a spring-biased normally-open switch connected to pass current from the trolling battery to the solenoid relays only when actuated so that upon release of the switch, the first and second electrical subsystem are restored to independent status.

6. A jumper switching device comprising:
two spring-biased solenoid relays having normally open contacts;
first and second positive battery-terminal cables interconnected with first and second contacts of a first one of the solenoid relays;
first and second negative battery-terminal cables interconnected with first and second contacts of a second one of the solenoid relays;
a switch interconnected between the first positive battery-terminal cable and coil of the solenoid relays at coil terminals; and
an electrical connection path from said coil terminals, through said coils to the first negative battery-terminal cable.

7. The device of claim 6, wherein the switch is spring-biased and is normally open.

8. The device of claim 7, wherein the switch is a pushbutton switch.

9. The device of claim 6, further comprising a waterproof box enclosing the solenoid relay and the electrical connection path.

10. The device of claim 6, wherein the positive and negative battery-terminal cables are no smaller the No. 4 American Wire Gauge (AWG).
